(19) United States
(12) Patent Application Publication
(10) Pub. No.: US 2010/0253409 A1
(43) Pub. Date: Oct. 7, 2010

(54) CLOCK GENERATION SYSTEM AND CLOCK DIVIDING MODULE

(75) Inventor: SHIH YI YEH, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/561,503

(22) Filed: Sep. 17, 2009

(30) Foreign Application Priority Data
Apr. 6, 2009 (TW) 098111334

(51) Int. Cl. G06F 1/04

(52) U.S. Cl. 327/295

(57) ABSTRACT

A clock gating system includes a clock divider, a first clock gating unit and a second clock gating unit. The clock divider is employed to generate clock signals with different frequencies. The first clock gating unit is configured for generating a gated clock to a first functional block, while the second clock gating unit is configured for generating a gated clock to a second functional block. Logically the first clock gating unit and the second clock gating unit are included in the first functional block and the to second functional block, respectively, and in physical layout the first clock gating unit and the second clock gating unit are disposed close to the clock divider.

### BACKGROUND OF THE INVENTION

1. Field of the Invention

The present invention relates to a clock generation system and a clock dividing module, and more particularly to a systematic clock generation system.

2. Description of the Related Art

In CMOS VLSI circuit designs, such as application specific integrated circuit (ASIC) designs, clock signals have a determining influence on the performance of chip functions. If a chip designer does not plan the clock distribution of each logic block carefully, then a clock skew, the difference in maximum and minimum time delay between a clock source and a clock sink, will degrade performance of the chip and cause failure of the system. Clock distribution networks also consume from 20% to 50% of the total chip power to maintain high speed operation and driving ability in the path between the clock source and the clock sink. Therefore, clock skew and power consumption are two chief factors chip designers must consider when designing the clock distribution network.

A well-known method for reducing power consumption in digital circuit designs is called clock gating technique. This technique divides a clock signal into several separate clock signals for controlling or disabling some portions of the chip not currently in use. FIG. 1 shows a block diagram of a conventional clock generation system 10. The clock generation system 10 comprises a clock generation module 12 for providing gated clocks and a plurality of functional blocks 1-N. The clock generation module 12 comprises a phase-locked loop (PLL) 14, a clock divider 16, and a plurality of clock gating units 1-J. The PLL 14 is configured to generate a clock signal, and the clock divider 16 is configured to receive the clock signal and generate a plurality of clock signals with different frequencies. The plurality of clock gating units 1-J are configured to receive the clock signal outputted from the clock divider 16 for generating a plurality of gated clock signals gated_clk₁-gated_clkⱼ.

The plurality of gated clock signals gated_clk₁-gated_clkⱼ are applied to logic circuits, such as flip flops, registers, or sequential logic circuits, in the plurality of functional blocks 1-N so as to provide the desired clock signals. When some portions of the logic circuits in the functional blocks 1-N are not currently in use, the functional blocks 1-N output a control signal control to inform the corresponding clock gating unit to disable the clock signal, and thus the power consumption of the system can be reduced.

However, with improvements in the process and increasing demands from users, the number and the area of the functional blocks required in chips is increasing rapidly. The clock gating technique mentioned above requires extra logic gates in implementation, and the logic gates increase the chip layout and power consumption. If a chip designer uses the conventional clock generation module to implement the clock gating technique, the circuit design becomes very complicated. Also, the functional blocks are located in different places inside a chip so that the clock skew of the gated clock signals increases as the length of wires increases. Therefore, it is desirable to provide a distributed clock gating system and a clock dividing module to reduce power consumption and reduce the complexity of the circuit design and verification.

### SUMMARY OF THE INVENTION

According to one embodiment of the present invention, a clock generation system comprises a clock divider, a first clock gating unit, and a second clock gating unit. The clock divider is configured to output clock signals with different frequencies. The first clock gating unit is configured for generating a gated clock to a first functional block and the second clock gating unit is configured for generating a gated clock to a second functional block. The first clock gating unit and the second clock gating unit are logically included in the first functional block and the second functional block, respectively, and are physically disposed close to the clock divider in a physical layout.

According to another embodiment of the present invention, a clock dividing module comprises a Gray code table generation unit, a clock dividing finite state machine, and a clock dividing generation unit. The Gray code table generation unit is configured to generate a two-dimensional array. The clock dividing finite state machine is configured to receive the two-dimensional array and a clock source signal, and a current state of the clock dividing finite state machine so as to generate a next state of the clock dividing finite state machine. The clock dividing generation unit is configured to receive the two-dimensional array, the clock source signal, and the current state of the clock dividing finite state machine so as to generate a divided clock signal.

### BRIEF DESCRIPTION OF THE DRAWINGS

The invention will be described according to the appended drawings in which:

FIG. 1 shows a block diagram of a conventional clock generation system;

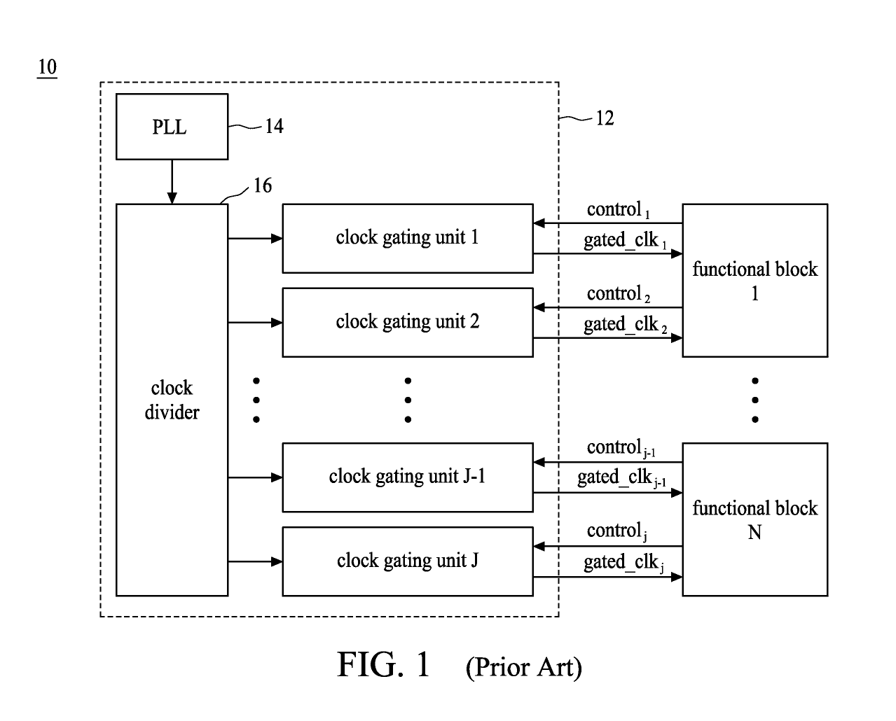

FIG. 2 shows a typical flow chart of the chip implementation by using a hardware description language according to one embodiment of the present invention;

FIG. 3 shows a clock generation system according to one embodiment of the present invention; and

FIG. 4 shows a clock dividing module according to one embodiment of the present invention.

### DETAILED DESCRIPTION OF THE INVENTION

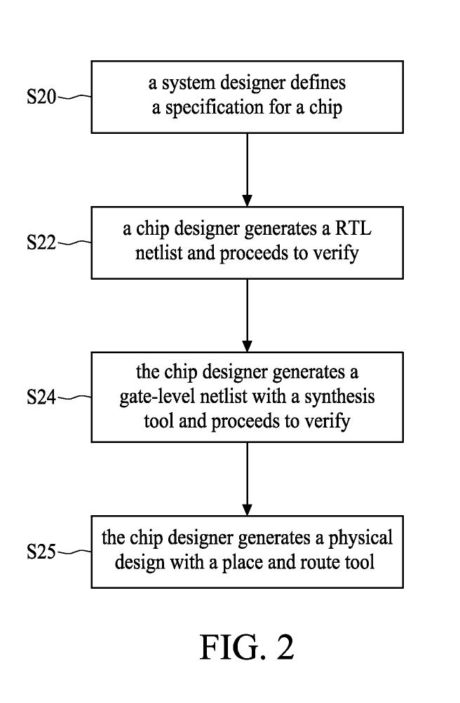

FIG. 2 shows a typical flow chart of the chip implementation by using a hardware description language (HDL) according to one embodiment of the present invention. The flow chart is configured to implement the present invention. Referring to FIG. 2, a system designer defines a specification for a chip in step S20. In step S22, a chip designer generates a register-transfer level netlist (RTL netlist) and proceeds to verify. In step S24, the chip designer generates a gate-level netlist with a synthesis tool and proceeds to verify. In step S25, the chip designer generates a physical design with a place and route tool. The details of each step of the flow chart are described below.

First, the system designer sets up the specification including functions, operating speed, interface specification, environmental temperature, and power consumption according to the application of the chip. When the specifications are set up, the system designer divides the chip into several functional blocks based on the function or other factors, and assigns the design to different designers to proceed to the follow-up steps. The designers use an HDL description, such as VERILOG or VHDL, to describe the behavior or the character of the functional blocks and use a compiler corresponding to the HDL description to translate the language into an RTL netlist. The RTL netlist comprises a set of nodes linked to each functional block, which defines Boolean logic to be implemented by the functional blocks in terms of math statements. Next, the designer uses a circuit simulator to verify the circuit behavior as described by the nodes. After the verification, the designer uses a synthesis tool to translate the RTL netlist into the gate-level netlist. The designer selects an appropriate logic cell library as a reference to synthesize gate-level logic circuits. The gate-level netlist describes the functional blocks more concretely using the logic cell library. The gate-level netlist verifies the circuit logic and the time-related behavior of the circuit with a simulation and a verification tool. After the verification, the place and route tool is used to generate a physical design, such as a layout, in accordance with the gate-level netlist.

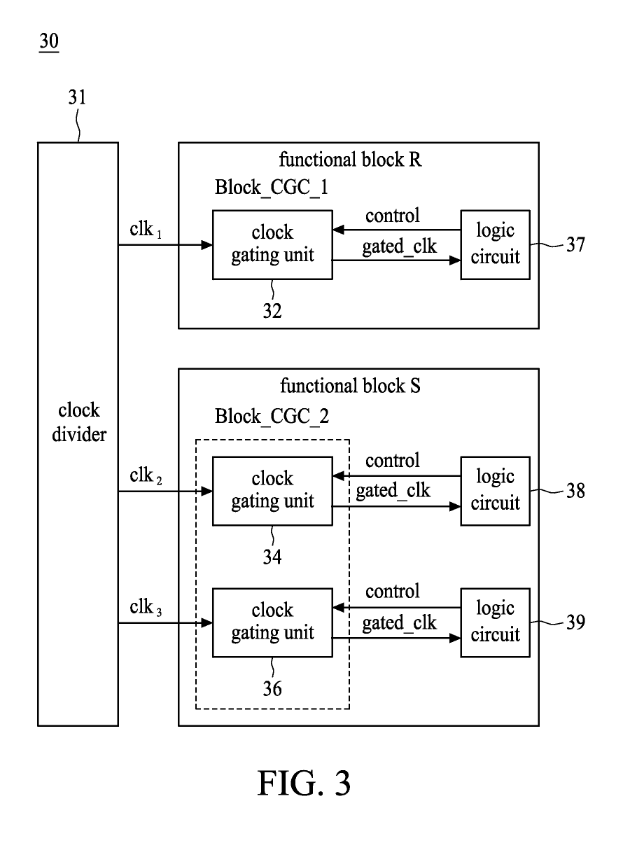

FIG. 3 shows a clock generation system 30 according to one embodiment of the present invention. The clock generation system 30 comprises a clock divider 31, a functional block R, and a functional block S. The clock divider 31 is configured to output clock signals with different frequencies. The major difference between the conventional method and the present invention is that a clock gating unit 32 is logically included in the respective functional block R rather than in the centralized clock generation module, and the positions of clock gating units 34 and 36 are logically included in the respective functional block S rather than in the centralized clock generation module. The clock divider 31 outputs clock signals clk₁, clk₂, and clk₃ to the clock gating units 32, 34, and 36, respectively. After receiving clock signals clk₁, clk₂, and clk₃ from the clock divider 31 and a control signal control from logic circuits 37, 38, and 39, the clock gating units 32, 34, and 36 generate gated clock signals gated_clk to the logic circuits 37, 38, and 39. Because the clock gating unit 32 and the logic circuit 37 are logically included in the functional block R and the clock gating units 34 and 36 and logic circuits 38 and 39 are logically included in the functional block S, the time and cost of the design and verification can be simplified. The clock gating units 32, 34, and 36 are physically disposed as close as possible to the clock divider 31 inside the clock divider 31 in physical layout, and thus the power consumption is reduced due to the shorter length of the clock signals clkᵢ, clk₂, and clk₃.

The RTL netlist and the gate-level netlist are usually represented as a hierarchical architecture. When the designer uses the clock generation system 30 to simulate a register-transfer level or a gate-level circuit, because the functional block R and the functional block S are described in the hierarchical architecture, the logic function and circuit between the functional block R and the clock gating unit 32 and between the functional block S and the clock gating unit 32 can be verified.

When the designer proceeds to layout in accordance with the gate-level netlist, the clock gating unit 32 included in the functional block R and the clock gating units 34 and 36 included in the functional block S can be assigned systematic names, such as Block_CGC_1 and Block_CGC_2, so that the designer can place them as close as possible to the position of the clock divider 31 to short the routing path in layout. In such way, the designer can identify the instances with the systematic name and the combination thereof by searching and can determine the positions of the instances in the chip. Because the high speed clock signals are distributed to the routing paths, the dynamic power consumption of the chip can be reduced significantly when the routing paths are shortened.

For further simplifying the design and verification processes, the present invention discloses a systematic clock dividing method. The systematic clock dividing method can easily expand clock signals with different frequencies by a regular statement. In the prior art, a clock dividing code can be described by an HDL description with a brute force manner, as shown below:

```
case (clk_state)
        6′b000_000: begin
                        next_state = 6′b000_001;
                        div3 = 1;
            end
        6′b000_001: begin
                        next_state = 6′b000_011;
                        div3 = 0;
                    end
          6′b000_011: begin
                            next_state = 6′b000_010;
                            div3 = 0;
                    end
          6′b000_010: begin
                            next_state = 6′b000_110;
                            div3 = 1;
                    end
          endcase
        always@(posedge clk) begin
          clk_state <= next_state;
          div3_clk <= div3;
        end
```

In above example, the clk_stage has a width of 6 bits and can be written into 64 states from (0 0 0 0 0 0) to (1 1 1 1 1 1). In this example, when the clock dividing code needs to generate a clock signal whose frequency is equal to the frequency of an input clock signal divided by 3, the initial state of a variable div3 is set to 1. The state of the variable div3 transforms with a state transition sequence of 0, 0, 1, 0, 0, 1, etc. when a positive edge of the input clock signal arrives, and therefore the output of the variable div3 is the clock signal whose frequency is equal to the frequency of the input clock signal divided by 3. Similarly, when the clock dividing code needs to generate a clock signal whose frequency is equal to the frequency of the input clock signal divided by 4, the initial state of a variable div4 is set to 1. The state of the variable div4 transforms with a state transition sequence of 0, 0, 0, 1, 0, 0, etc. when a positive edge of the input clock signal arrives, and therefore the output of the variable div4 is the clock signal whose frequency is equal to the frequency of the input clock signal divided by 4. As mentioned above, the clock dividing code generated in a brute force manner becomes very complex, tedious, and hard to maintain with an increasing number of divided frequencies provided to functional blocks. However, with the formula-based clock dividing module disclosed by the present invention, clock signals with different frequencies can be obtained much more easily, which therefore simplifies the subsequent simulation and verification steps.

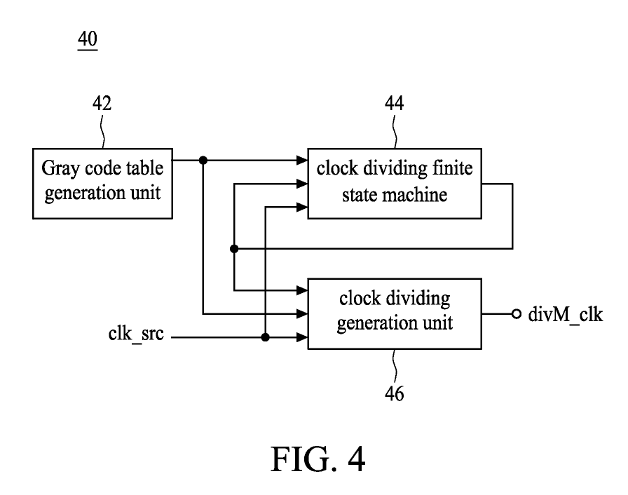

FIG. 4 shows a clock dividing module 40 according to one embodiment of the present invention. The clock dividing module 40 comprises a Gray code table generation unit 42, a clock dividing finite state machine 44, and a clock dividing generation unit 46. The Gray code table generation unit 42 is configured to generate a two-dimensional array (2D array) T. Each entry in the 2D array T is generated according to a Gray code encoding method. The 2D array T can be described by an HDL description and is shown below:

```
    wire [L−1:0] T[1<<L]−1:0]
    assign T[0]=L′h0;
    generate
        for(i=0;i<L;i=i+1) begin:fg_GCT_1
            for(j=(1<<i);j<(1<<i+1));j=j+1)begin:fg_GCT_2
                assign T[j]=T[((i<<i)−1)−(j−(1<<i))]|(1<<i);
            end
        end
    endgenerate
wherein L, I and j are constants.
```

For illustrating the gray table generated by the above HDL description more simply, L is now substituted for 6. When L=6, a 2D array T is generated, wherein the entry T[0]=6′h0=0, entry T[1]=6′h1=1, entry T[2]=6′h3=3, entry T[3]=6′h2=2, etc. in the 2D array T. The entries T[0] to T[63] are generated according to the Gray code encoding method. In the Gray code encoding method, adjacent code words are different in only one bit position. Therefore, the dynamic power consumption is lower when a circuit uses this encoding method.

After establishing the 2D array T with the Gray code encoding method, the clock dividing finite state machine 44 is configured to receive the 2D array T, a clock source signal clk_src, and a current state of the clock dividing finite state machine 44 so as to generate a next state. The clock dividing generation unit 46 is configured to receive the 2D array T, the clock source signal clk_src, and the current state of the clock dividing finite state machine 44 so as to generate a divided clock signal with a different frequency and a different duty cycle.

The circuit behavior of the clock dividing finite state machine 44 and the clock dividing generation unit 46 can be described by an HDL description and is shown below:

```
    generate
        for(i=0;i<N;i=i+1) begin:fg_clk_div
            assign ns[i]=(S==T[i])?T[(i+1)%N](i==0?T[0]:ns[i−1]);
            assign divM[i]=(S==T[i])?i%M<K)(i==0?0:divM[i−1]);
        end
    endgenerate
    always@(posedge clk)begin
        S<=ns[N−1];
          divM_clk<=divM[N−1];
      end
wherein L, i, K and N are constants, and M is a constant equal to or greater than 2.
```

In one embodiment, the clock dividing finite state machine 44 comprises repeatedly describing means for receiving an accumulating signal to execute a loop operation. The repeatedly describing means comprises first condition operating means. The first condition operating means is configured to generate a next state ns[i] of the clock dividing finite state machine 44 by comparing the current state S with a vector in the 2D array T (i.e., T[i]) and by examining a loop index i., wherein the vector is obtained by using the loop index i to index into the 2D array T.

In one embodiment, the first condition operating means is configured to generate the next state ns[i] by the following statement:
assign ns[i]=(S==T[i])?T[(i+1) % N](i==0? T[0]:ns[i−1]);

When the value of the current state S is equal to T[i], the value of the next state ns[i] is set to T[i+1]. For example, when i=1 and N=64, if the value of the current state S=T[1]=1, then the next state ns[1] will be equal to T[2]=3. When i=2, if the value of the current state S=T[2]=3, then the next state ns[2] will be equal to T[3]=6, etc. When i=63, if the value of the current state S=T[63], then the next state ns[64] will return to T[0]=0, and the cycle will be repeated from T[1], T[2], T[3], etc. In this case, the next state ns[i] is a vector in the 2D array T with the index equal to the loop index i plus 1.

In one embodiment, the clock dividing generation unit 46 comprises a second condition operating means. The second condition operating means is configured to generate a divided clock signal divM_clk whose frequency is equal to the clock source signal clk_src divided by M, and the divided clock signal divM_clk is obtained by comparing the current state S of the clock dividing finite state machine 44 with a vector in the 2D Gray code table (i.e., T[i]) and by examining the value of a loop index i when it divided by an integral. For example, when the value of the current state S is equal to T[i] and the remainder of the loop index i divided by the constant M is less than the constant K, then the value of a variable divM[i] is equal to 1. In one embodiment, when K=2 and M=4, the second condition operating means is configured to generate a divided clock signal div4_clk by the following statement:
assign div4[i]=(S==T[i])?i %4<2)(i==0? 0:div4[i−1])

The divided clock signal div4_clk is obtained by the clock source signal clk_src divided by 4, and the duty cycle of the divided clock signal div4_clk is 0.5. According to the statement, when i=0, the remainder of i divided by 4 is 0, and thus i %4<2 is true and div4[0]=1. When i=1, the remainder of i divided by 4 is 1, and thus i %4<2 is true and div4[1]=1. When i=2, the remainder of i divided by 4 is 2, and thus i %4<2 is false and div4[2]=0. When i=3, the remainder of i divided by 4 is 3, and thus i %4<2 is false and div4[3]=0, etc. As a result, the frequency of the divided clock signal div4_clk is the frequency of the clock source signal clk_src divided by 4 and the duty cycle is 0.5.

When a logic circuit requires a divided clock signal div6_clk whose frequency is equal to the frequency of the clock source signal clk_src divided by 6 and duty cycle is 0.5, then the divided clock signal div6_clk is obtained if the constant M and the constant K of the second condition operating means are substituted by 6 and 3, respectively. When a logic circuit requires a divided clock signal div4x_clk whose frequency is equal to the frequency of the clock source signal clk_src divided by 4 and duty cycle is 0.25, then the divided clock signal div4x_clk is obtained if the constant M and the constant K of the second condition operating means are substituted by 4 and 1, respectively. Therefore, the frequency of the divided clock signal can be determined by the constant M, and the duty cycle of the divided clock signal can be determined by comparing the reminder to the constant K. Accordingly, with the formula-based clock dividing module disclosed by the present invention, clock signals with different frequencies and different duty cycles can be obtained much more easily, which therefore simplifies the subsequent simulation and verification steps.

The above-described embodiments of the present invention are intended to be illustrative only. Numerous alternative embodiments may be devised by those skilled in the art without departing from the scope of the following claims.

What is claimed is:

1. A clock generation system, comprising:
a clock divider configured to output clock signals with different frequencies;
a first clock gating unit for generating a gated clock to a first functional block; and
a second clock gating unit for generating a gated clock to a second functional block;
wherein the first clock gating unit and the second clock gating unit are logically included in the first functional block and the second functional block, respectively, and are physically disposed close to the clock divider in a physical layout.

2. The clock generation system of claim 1, wherein the first clock gating unit receives a first control signal from a first logic circuit and a first clock signal with a first frequency from the clock divider for generating a first gated control signal to the first logic circuit, and the second clock gating unit receives a second control signal from a second logic circuit and a second clock signal with a second frequency from the clock divider for generating a second gated control signal to the second logic circuit.

3. The clock generation system of claim 1, wherein the first and second clock gating units have systematic names.

4. The clock generation system of claim 3, wherein the first and second clock gating units are disposed close to the clock divider during the physical layout by means of the systematic names.

5. A clock dividing module, comprising:
a Gray code table generation unit configured to generate a two-dimensional array;
a clock dividing finite state machine configured to receive the two-dimensional array and a clock source signal and a current state of the clock dividing finite state machine so as to generate a next state of the clock dividing finite state machine; and
a clock dividing generation unit configured to receive the two-dimensional array, the clock source signal and the current state of the clock dividing finite state machine so as to generate a divided clock signal.

6. The clock dividing module of claim 5, wherein each entry in the two-dimensional array is generated according to a Gray code encoding method.

7. The clock dividing module of claim 5, wherein the clock dividing finite state machine further comprises repeatedly describing means for receiving an accumulating signal to execute a loop operation.

8. The clock dividing module of claim 7, wherein the clock dividing finite state machine further comprises first condition operating means configured to generate a next state of the clock dividing finite state machine by comparing the current state with a vector in the two-dimensional Gray code table and by examining a loop index.

9. The clock dividing module of claim 8, wherein the vector is obtained by using the loop index to index into the Gray code table.

10. The clock dividing module of claim 7, wherein the next state is a vector in the Gray code table with an index equal to the loop index plus 1.

11. The clock dividing module of claim 5, wherein the clock dividing generation unit further comprises second condition operating means configured to generate the divided clock signal by comparing the current state of the clock dividing finite state machine with a vector in the 2-dimensional Gray code table and by examining the value of a loop index.

12. The clock dividing module of claim 11, wherein the loop index is divided by a constant integer to obtain a remainder.

13. The clock dividing module of claim 12, wherein the constant integer is configured to determine a frequency of the divided clock signal.

14. The clock dividing module of claim 12, wherein the remainder is compared to another constant integer to decide a duty cycle of the divided clock signal.
